(19) United States
(12) Patent Application Publication
(10) Pub. No.: US 2006/0131229 A1
(43) Pub. Date: Jun. 22, 2006

(54) Apparatus for and method of waste treatment using vermiculture

(76) Inventor: Malcolm Claude Baillie, Norwood (AU)

Correspondence Address: NIXON & VANDERHYE, PC, 901 NORTH GLEBE ROAD, 11TH FLOOR, ARLINGTON, VA, 22203, US

(21) Appl. No.: 11/019,096

(22) Filed: Dec. 22, 2004

(51) Int. Cl. C02F 3/00

(52) U.S. Cl. 210/601

(57) ABSTRACT

Apparatus for treating waste using vermiculture including a plurality of slats arranged in side-by-side relationship to form a vermiculture support and slat mounting means to which each of the slate is mounted, wherein some of the slats are mounted in abutting side-by-side relationship to one another to a width sufficient to support a first bed of feedstock for vermiculture and the remainder of the slats are arranged in spaced side-by-side relationship, the spacing being selected to provide for aeration of a bed of vermiculture feedstock which has been digested by a colony of selected worms.

### FIELD OF INVENTION

THIS INVENTION relates to apparatus for and a method of waste treatment using vermiculture. The invention is primarily directed to the composting of “green waste” to produce a compost for agriculture. However, the invention is not limited to such applications or uses.

### BACKGROUND ART

The predominant use of vermiculture has been for the production of worms for agricultural use in soil conditioning or as fish-bait. The feedstock for worms is primarily formed from comminuted vegetable matter, particularly compostible waste material. The spent worm food, including worm castings, is sometimes used as fertiliser. Vermiculture has also been used to is a limited extent as a process for treatment of compostible waste matter per se. In this specification, the term “feedstock” is used to refer to the material prepared for feeding worms.

One known vermiculture method uses windrows of feedstock to be consumed by particular types of worms which feed within a portion of each windrow, typically about 100 mm from the outer surface of the windrow. After being allowed to feed on one windrow, another windrow is established adjacent thereto and the worms then migrate to the new windrow, the feedstock of the abandoned windrow having been substantially depleted of suitable food material for the worms causing the migration of the worms seeking fresh feedstock. After a number of generations of windrows, the worms have normally undergone a natural increase and may be harvested, whereupon each spent windrow may be packed or bagged up as compost. This method is slow, inefficient and requires a large area of land to be carried out successfully. Moreover, a significant amount of feedstock is left undigested by the worms. Additionally, the compost produced is often of poor quality.

Other industrial scale methods have been used which, in a typical example, involve the addition of feedstock to a bin and then worms are introduced to colonise the feedstock in the bin. Layers of feedstock are added at time-spaced intervals until a desired operating level is established in the bin. As each fresh layer is added, the worms migrate upwards to consume the fresher feedstock in the fresh layer, the timing of the time-spaced interval being such that the a desired amount of vermicultural processing of the layer is effected. A layer of processed material may be removed from time to time from the bottom of the bin, the removed layer typically equating to a layer which had been added earlier in the process. Typically, the bottom layer is removed once the desired operating level is established, so that a new layer of feedstock may be added to re-establish the operating level, thereby providing a stage-wise continuous processing of the feedstock for the production of compost. However, as fresh feedstock is spread on top of the previous layer, moisture trickles downward and the bottom layer, when removed, can be undesirably wet. Additionally, anaerobic conditions may also develop in the lower layers, sometimes resulting in the generation of pathogenic organisms to undesirable levels and poor quality compost.

The present invention aims to provide apparatus for and a method of waste treatment using vermiculture which ameliorates one or more of the shortcomings of the prior art. The invention also aims to provide apparatus for and a method of waste treatment using vermiculture which produces a more fully processed compost than prior art apparatus and/or methods. The invention also aims to provide apparatus for and a method of waste treatment using vermiculture which produces compost having specific characteristics. Other aims and advantages of the invention may become apparent from the following description.

### DISCLOSURE OF INVENTION

With the foregoing in view, this invention resides broadly in a method of waste treatment using vermiculture including forming a first bed of feedstock to a first depth;

colonising the first bed with a plurality of worms selected for substantially complete occupation of the feedstock and allowing the worms to process the feedstock for a time sufficient to produce a first stage feedstock;

forming the first stage feedstock into a second bed having a second depth being a fraction of that of the first bed and a width commensurate with the fractional depth;

forming a new first bed of feedstock in such disposition with respect to the second bed as to permit the worms from the second bed migrate substantially completely to the new first bed;

leaving the second bed for a time sufficient for substantially complete migration of the worms from the second bed to the first bed; and

removing the second bed.

Preferably, the second bed is left whilst permitting aeration thereof for a time sufficient to dry the second bed to produce a compost product. The method also preferably includes covering the first bed to prevent or limit dessication of the feedstock. The method is preferably carried out in a stage-wise continuous production environment by repeating the relevant steps or portions of the method described herein. Accordingly, the worms introduced into the initial first bed are permitted to migrate to successive new first beds from successively formed new second beds which are removed in turn. Occasionally, the first bed may be started afresh with a new population of worms. It is also preferred that the method be carried out in plurality starting at timed intervals to permit processing operations on some of the first and/or second beds whilst the remaining are undergoing vermicultural processing. Preferably, the second bed and second beds are formed in side-by-side disposition substantially horizontally with respect to one another. In such form, as the successive repetitions of the process are performed, the subsequent first and second beds occupy substantially the same location.

It is also preferred that the properties of the compost product be adjusted to provide desired specific characteristics by addition of one or more feed supplements to the feedstock. In such form, the feed supplements may be, for example, selected for providing desired components or trace elements, in the compost product, such as, for example, potash, selenium, nitrogen or the like. The selected worms may come from one or more species or varieties or worms known to occupy feedstock and digest it to a desired depth of feedstock substantially completely.

In another aspect, the present invention resides in apparatus for treating waste using vermiculture and including:

first support means for supporting a first bed of vermiculture feedstock; and

second support means adjoining the first support means for supporting a second bed of vermiculture feedstock, the second support means being provided with a plurality of apertures for aeration of the second bed of feedstock, at least some of the aeration being provided through the apertures.

Preferably, a containment wall surrounds the first and second support means for containing the vermiculture feedstocks on the first and second support means.

In another aspect, this invention resides broadly in apparatus for treating waste using vermiculture including

a plurality of slats arranged in side-by-side relationship to form a vermiculture support; and

slat mounting means to which each of the slate is mounted, wherein some of the slats are mounted in abutting side-by-side relationship to one another to a width sufficient to support a first bed of feedstock for vermiculture and the remainder of the slats are arranged in spaced side-by-side relationship, the spacing being selected to provide for aeration of a bed of vermiculture feedstock which has been digested by a colony of selected worms.

Preferably, the slats in abutting relationship form first support means and the spaced slats form second support means as herein described. Preferably, a containment wall is provided extending upward from the periphery, preferably all of the periphery, of the vermiculture support for containing vermiculture feedstock on the vermiculture support.

Preferably, removable covering means is provided in operative association with the first support means for substantially covering the first bed of vermiculture feedstock. More preferably, containment wall is of a height substantially the same as the required depth of the first bed and the covering means is mounted to the containment wall alongside the first bed. It is further preferred that the second support means have substantially double the support area of the first support means whereby the waste treatment apparatus may be used for the method of the invention as herein described and having a fractional depth half that of the first bed. In a preferred form, the waste treatment apparatus has a substantially rectangular footprint, the first and second support means being elongate along the longer sides. In such form, the waste treatment apparatus is formed as a tray with the height of the containment wall being 100 mm, and the support means and containment means are formed from a material compatible for the culturing of worms, such as, for example, timber or the like. Although the worm population is selected to be suited to the 100 mm depth for the first bed, a lesser depth may be provided. A course, a different population of worms may be selected for the processing of first-bed depths of depths other than 100 mm. The width of the second support means is preferably twice that of the first so that height of the second bed may be formed to be is half that of the first bed. If a different selection is worms is provided which has different feeding characteristics, the ratio of the widths of the first and second support means may be changed to provide a commensurate ratio in the ratio of the depths first and second beds, the depth of the first bed being selected to accommodate the feeding characteristics of the worms selected for feeding therein, and the depth of the second bed being selected to accommodate the drying characteristics of the digested feedstock and/or migratory habits of the worms leaving the second bed for the new first bed formed in operative disposition in relation thereto.

It is also preferred that a plurality of trays be provided, and these may be mounted in respective tray supports in vertically spaced relationship with one another to maintain sufficient aeration of the second support means. Where wooden trays are provided, it is preferred that the second support means be formed from a plurality of slats in substantially parallel spaced relationship with one another and a flexible supporting membrane be provided above the slates to prevent the vermiculture feedstock falling through the gaps between the slats. Furthermore, a plurality of such stacks may be provided in side-by-side relationship to form an array of vermiculture trays.

Preferably, the tray supports are arranged to provide complete lateral removal of each tray from the stack to permit access to the vermiculture beds. One or more trays may be removed at a time from the array for processing and/or performing the method of the invention. That includes removing the compost product from the second support means, spreading the first bed onto the second support means to form a new second bed and adding fresh feedstock to the first support means so that there is sufficient contact therewith for migration of the worms (where contact is required for such migration).

In another aspect, this invention resides broadly in a method of treating waste including:

providing a plurality apparatus for treating waste using vermiculture as herein described;

mounting each apparatus to retractable mounting means arranged to stack the apparatus vertical spaced relationship with each other to a spacing sufficient to provide a required for aeration of each apparatus;

wherein the retractable mounting means is arranged to provide, at an appropriate time, removal of each apparatus one or more at a time to an extent sufficient to permit forming a first bed of feedstock for colonisation with a plurality of worms, forming the first bed into a second bed and/or removing the second bed.

and wherein the retractable mounting means is arranged to provide returning of the one or more apparatus to the stack to allow the worms to process the feedstock and/or to migrate from the second bed to the first bed.

In another aspect, the present invention resides broadly in a method of waste treatment using vermiculture including forming a first bed of feedstock and colonising the first bed with a plurality of worms selected for substantially complete occupation of the feedstock and allowing the worms to process the feedstock for a time sufficient to produce a first stage feedstock, forming the first stage feedstock into a second bed, forming a new first bed of feedstock in such disposition with respect to the second bed as to permit the worms from the second bed migrate substantially completely to the new first bed, leaving the second bed for a time sufficient for substantially complete migration of the worms from the second bed to the first bed, and removing the second bed.

Preferably, the dry cast from the second bed is removed by pneumatic means. Accordingly, a blower apparatus, or alternatively, a vacuum apparatus, is provided for the pneumatic transport of the dry cast to a holding location for further processing.

The dry cast from the second bed may be further processed. For example, a measured quantity of the dry cast may be placed into a first container having a bottom drainage port. Filtration means (a drainage filter) is provided in the drainage port, which connects to a drainage line to provide fluid communication to a second container via an entry port above the maximum liquid level of the second container. The first container also has an overflow port at the maximum liquid level and providing fluid connection to an overflow line. Filtration means (an overflow filter) is provided in the overflow line which is also in fluid connection with the second container by way of an overflow inlet port above the maximum liquid level of the second container. A return port is also provided in the first container in fluid connection with a return line.

A submersible pump is provided in the second container and has a pump outlet in fluid connection with the return line to the first container. The pump is operable for pumping liquid from the second container to the first container whereupon the liquid being pumped disperses the dry cast. The liquid is drained through the drainage port back to the second container which preferably has a capacity greater than that of the first container. The pump provides a measured flew of liquid to recirculate and leach soluble material from the dry cast into the liquid, typically water, or at least usually an aqueous liquid, through the drainage line to the second container. The overflow line permits continued operation in case the drainage filter becomes blocked or obstructed. A reticulation system may be provided in the first container to enhance oxygenation of the liquid, but having the entry and overflow ports above the liquid level permits at least some, and normally provides sufficient, oxygenation of the liquid by providing a drop into the liquid in the second container. Oxygenation control is believed to be necessary to maintain microorganism colony activity, and reticulation flow speed is believed to be necessary to maintain micro-organism colony count.

Parameters of the recirculating liquid may be measured, such as, for example, conductivity and pH, whereby, once desired levels are achieved, the liquid may be led off to storage and/or packaging, the containers cleaned out, and the process restarted.

### BRIEF DESCRIPTION OF THE DRAWINGS

In order that the invention may be more readily understood and put into practical effect, reference will now be made to the accompanying drawings which illustrate a preferred embodiment of the invention and wherein:—

FIG. 1 is a plan view of waste treatment apparatus according to the invention;

FIG. 2 is a from elevation of the waste treatment apparatus of FIG. 1;

FIG. 3 is a detailed view of the end of the waste treatment apparatus of FIG. 2;

FIG. 4 is an end view of the waste treatment apparatus of FIGS. 1 and 2;

FIG. 5 is a detailed front elevation of the waste treatment apparatus of FIGS. 1 and 2;

FIG. 6 is a part sectional view along line AA of FIG. 5;

FIG. 7 is a diagrammatic side view of the waste treatment apparatus of FIG. 1 stacked in a stacking array;

FIG. 8 is an end view of the arrangement shown in FIG. 7;

FIG. 9 is a plan view of the arrangements shown in FIG. 7;

FIG. 10 is an end view of the arrangement shown in FIG. 7;

FIG. 11 is a detailed end view of the arrangement of FIG. 7;

FIG. 12 is a detailed side view of the arrangement shown in FIG. 7;

FIG. 13 is a diagrammatic view of the front of an array showing a plurality of waste treatment apparatus end on;

FIG. 14 is a diagrammatic view of the end of the array shown in FIG. 13;

FIG. 15 is an alternative arrangement of the array shown in FIGS. 13 and 14; and

FIG. 15 is a diagrammatic view of the end of the array shown in FIG. 14.

### DETAILED DESCRIPTION OF THE DRAWINGS

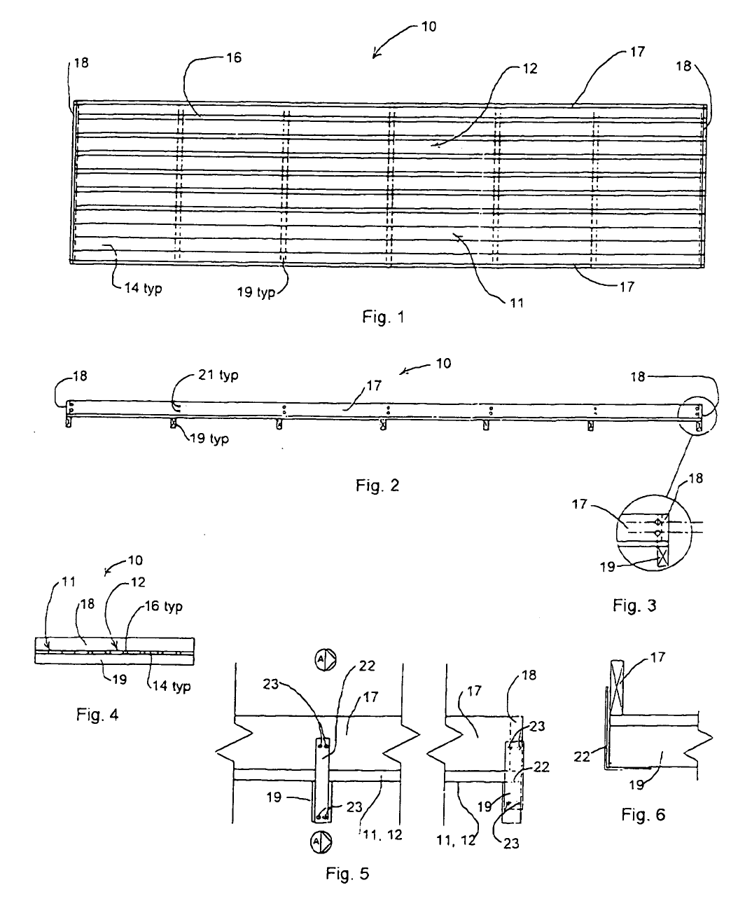

The waste treatment apparatus 10 shown in FIGS. 1 to 6 includes a first support portion shown generally at 11 and a second support section shown generally at 12 alongside the first support portion. Each support portion is formed with a plurality of slats shown typically at 14 side-by-side one another, abutting one another in the first support portion, but spaced from one another by a gap shown typically at 16 in the second support portion. The slats are arranged to provide a rectangular tray arrangement with two side walls 17 upstanding from the outside edges of the first and second support portions and two end panels 18 upstanding from the outside edges of the ends of the first and second support portions to form a containment wall. The slats of each support portion are mounted to seven cross members arranged across and underneath each slat from one outside edge to the other of the tray. The cross members also provide strength and stiffness to the tray. A flexible cover sheet (not shown) is attached to the elongate side wall along the outside edge of the first support portion, being fastened thereto by seven pairs of fasteners shown typically at 21.

From the details shown in FIG. 5, it can be seen that the side walls are mounted to the support portions by providing an angle bracket 22 fastened to the ends of each cross member 15 and to the side wall by four fasteners 23. As can be seen by referring to FIG. 6, the angle bracket extends part way under each cross member.

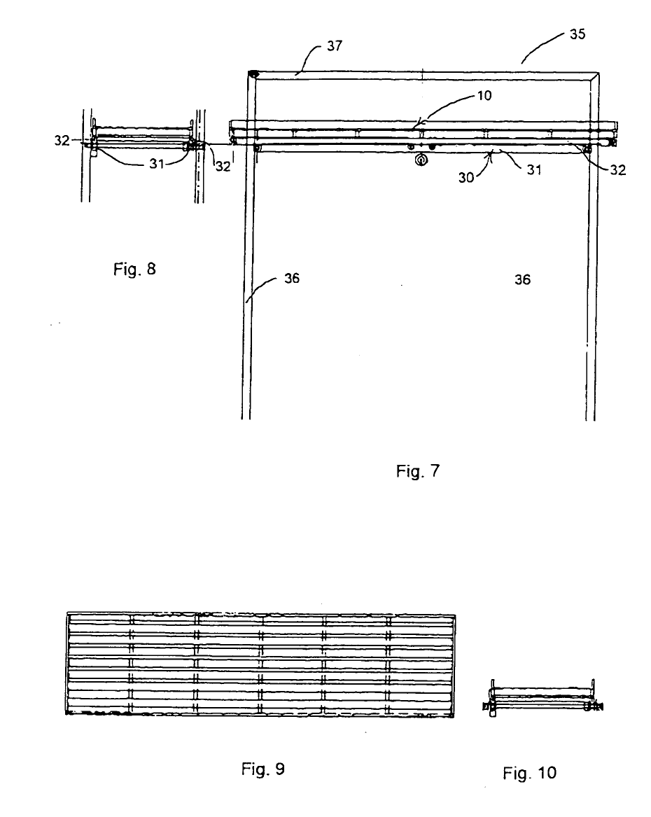

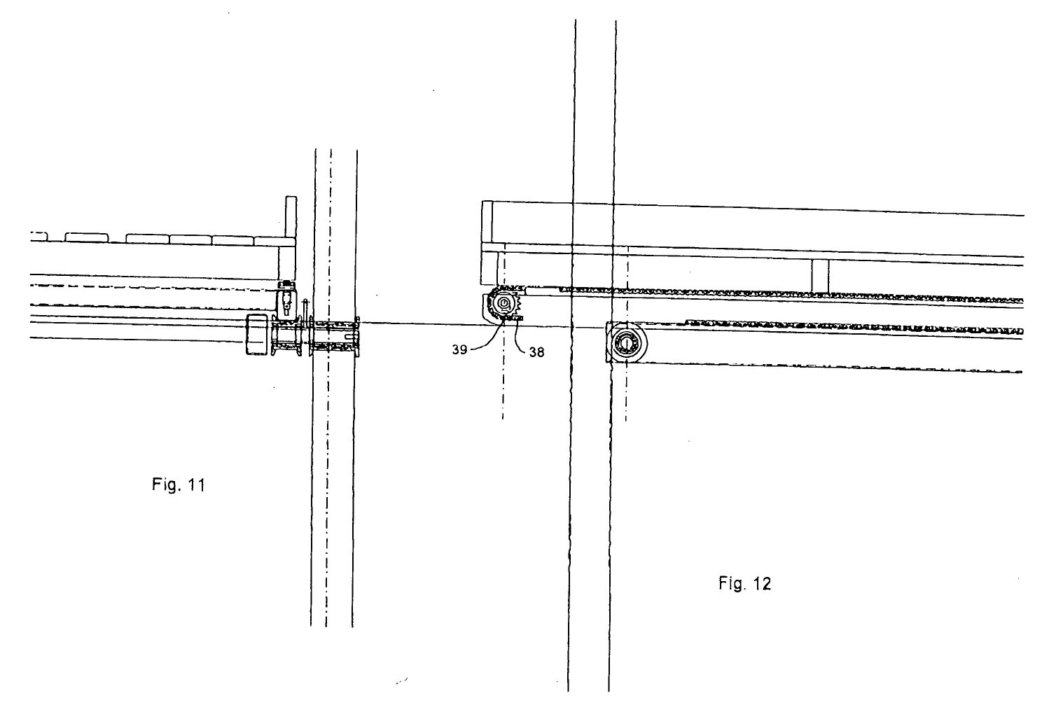

Referring to FIGS. 7 to 12, a plurality of waste treatment apparatus (only one of which is shown in FIG. 7 to 12) are mounted on a drawer mechanism 30 having two sets of rails, a lower set 31 operatively associated with an upper set 32 mounted to the elongate under side of the waste treatment apparatus. The drawer mechanism is mounted to a mounting frame 35 having two styles 36 and a top rail 37. The two styles are mounted substantially vertically and in parallel spaced relationship such that by operation of the drawer mechanism the waste treatment apparatus can be withdrawn completely from the frame. Thus, complete access to the waste treatment apparatus can be achieved. As can be seen in FIG. 12 in particular, a chain 38 is mounted to sprockets (one of which is shown at 39) so that the upper rails 32 can slide out completely when the lower rails 31 are withdrawn to half way out from the outer limits of the frame.

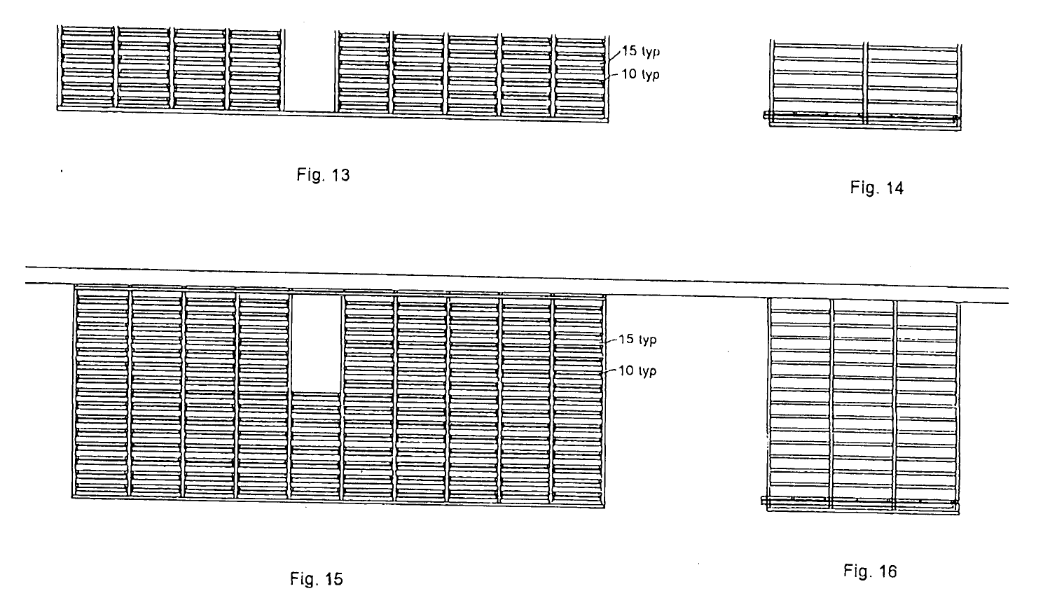

Ten stacked columns of waste treatment apparatus are shown in FIGS. 13 to 15 in the form of trays shown typically at 10 and with a spacing shown typically at 15. The height of the stacks is determined, for example, by the height of the building which houses the apparatus. In FIG. 13, the trays are stacked six high with an access gap in the fifths row from the left. In FIG. 14, the trays are stacked fifteen high except for the column fifth from the left which is stacked eight high. In each stack, the trays are spaced from one another to provide for ventilation, particularly in relation to the second support portion of each tray in which the first stage processed material is aerated and partly desiccated in accordance with the method the invention.

Waste treatment apparatus in accordance with the invention may used for producing compost having desired characteristics by supplementing the feedstock as herein described. A range of compost products having characteristics suitable for particular applications may be provided. For processing of compostible or putrescible, the feedstock is generally processed to produce worm-comestible material. Typically, local government or waste disposal authorities would establish a worm-farm type facility sized to the throughout of waster material generated in the locality. The trays are generally arranged in multiple stacked arrays similar to those shown in FIGS. 13 and 14 though larger or smaller arrays may be provided and multiple banks of arrays can be arranged in accordance with the requirements of the particular system being installed.

Fresh feed stock may be added to the trays in turn along the first support portion so that a substantially continuous, though stage-wise, process can be effected for the particular installation. For larger installations, several trays may be manipulated at the same time, depending upon the residence time of the particular part of the process requiring withdrawal of the tray from the array at a particular time. During the intervening part of each stage of the waste treatment or vermiculture process, the trays are inserted into the array in substantial vertical alignment with one another and, if required, ventilation, forced or otherwise, is provided. The apparatus is installed in a building having the appropriate flooring roofing and walls to maintain a substantially stable suitable environment and to protect against weather, particularly incursion of precipitation.

As an alternative to the arrangement of drawer-style stacking of the trays, a simple stacking system may be provide and a trolley provided having accurate tracking, such as railway-type of mounting, to permit a tray supporting jib or set of tines to be used for retrieving trays from the stack and moving them to a processing location.

Although the apparatus for and a method of waste treatment using vermiculture of the present invention has been described with reference to one or more specific examples, it will be appreciated by persons skilled in the arc that the invention may be embodied in other forms within the broad scope and ambit of the invention as defined by the following claims.

1. A method of waste treatment using vermiculture including forming a first bed of feedstock to a first depth;
colonising the first bed with a plurality of worms selected for substantially complete occupation of the feedstock and allowing the worms to process the feedstock for a time sufficient to produce a first stage feedstock;
forming the first stage feedstock into a second bed having a second depth being a fraction of that of the first bed and a width commensurate with the fractional depth;
forming a new first bed of feedstock in such disposition with respect to the second bed as to permit the worms from the second bed migrate substantially completely to the new first bed;
leaving the second bed for a time sufficient for substantially complete migration of the worms from the second bed to the first bed; and
removing the second bed.

2. The method according to claim 1, wherein the second bed is left whilst permitting aeration thereof for a time sufficient to dry the second bed to produce a compost product.

3. The method according to claim 1 or claim 2, wherein the first bed is covered to prevent or limit dessication of the feedstock.

4. A method of waste treatment using vermiculture carried out in a stage-wise continuous production environment by repeating the relevant steps or portions of the method according to any one of claims 1 to 3.

5. The method according to claim 4, wherein the worms introduced into the initial first bed are permitted to migrate to successive new first beds from successively formed new second beds which are removed in turn.

6. The method according to claim 5, wherein occasionally, the first bed is started afresh with a new population of worms.

7. A method of waste treatment using vermiculture, wherein the method according to claim 5 or claim 6 is carried out in plurality starting at timed intervals to permit processing operations on some of the first and/or second beds whilst the remaining are undergoing vermicultural processing.

8. Apparatus for creating waste using vermiculture and including:
first support means for supporting a first bed of vermiculture feedstock; and
second support means adjoining the first support means for supporting a second bed of vermiculture feedstock, the second support means being provided with a plurality of apertures for aeration of the second bed of feedstock, at least some of the aeration being provided through the apertures.

9. Apparatus according to claim 8, wherein a containment wall surrounds the first and second support means for containing the vermiculture feedstocks on the first and second support means.

10. Apparatus for creating waste using vermiculture including:
a plurality of slats arranged in side-by-side relationship to form a vermiculture support; and
slat mounting means to which each of the slate is mounted, wherein some of the slats are mounted in abutting side-by-side relationship to one another to a width sufficient to support a first bed of feedstock for vermiculture and the remainder of the slats are arranged in spaced side-by-side relationship, the spacing being selected to provide for aeration of a bed of vermiculture feedstock which has been digested by a colony of selected worms.

11. Apparatus according to claim 10, wherein the slats in abutting relationship form first support means and the spaced slats form second support means as herein described.

12. Apparatus according to claim 10 or claim 11, wherein the vermiculture support includes a containment wall extending upward from its periphery of for containing vermiculture feedstock on the vermiculture support.

13. Apparatus according to any one of claims 8 to 12, wherein removable covering means is provided in operative association with the first support means for covering the first bed of vermiculture feedstock.

14. Apparatus according to claim 14, wherein the containment wall is of a height substantially the same as the required depth of the first bed and the covering means is mounted to the containment wall alongside the first bed.

15. A method of waste treatment using vermiculture including forming a first bed of feedstock and colonising the first bed with a plurality of worms selected for substantially complete occupation of the feedstock and allowing the worms to process the feedstock for a time sufficient to produce a first stage feedstock, forming the first stage feedstock into a second bed, forming a new first bed of feedstock in such disposition with respect to the second bed as to permit the worms from the second bed migrate substantially completely to the new first bed, leaving the second bed for a time sufficient for substantially complete migration of the worms from the second bed to the first bed, and removing the second bed.

16. The method according to claim 15, wherein the dry cast from the second bed is removed by pneumatic means.

17. Apparatus for treating waste using vermiculture substantially as hereinbefore described with reference to any one of FIGS. 1 to 16.
